(19) United States
(12) Patent Application Publication
(10) Pub. No.: US 2026/0233954 A1
(43) Pub. Date: Aug. 13, 2026

(54) METHOD FOR LOADING AND/OR UNLOADING A LOADING SPACE, IN PARTICULAR THE LOADING SPACE OF A TRUCK, USING AN AUTONOMOUS LOADING VEHICLE AND SAFEGUARDING SYSTEM

(71) Applicant: SICK AG, Waldkirch (DE)

(72) Inventors: Michael TSCHIERSCHKY, Köln (DE); Peter BEU, Vettweiß (DE)

(21) Appl. No.: 19/532,030

(22) Filed: Feb. 6, 2026

(30) Foreign Application Priority Data
Feb. 7, 2025 (DE) 10 2025 104 555.0

(51) Int. Cl. B65G 65/00; B65G 67/04; B66F 9/06; B66F 17/00

(52) U.S. Cl. CPC B65G 65/005; B65G 67/04; B66F 9/063; B66F 17/003; B65G 2203/044; B65G 2207/40

(57) ABSTRACT

A method for loading and/or unloading a loading space uses an autonomous loading vehicle that drives into the loading space at least once in order to pick up and/or place at least one load object. An access zone of the loading space is safeguarded by a stationary sensor device having a first sensor, which is arranged at the access zone and which monitors a stationary protective field. The loading vehicle is safeguarded by a mobile sensor arrangement at the loading vehicle that at least temporarily monitors a contour field adapted to a structural boundary of the access zone. The mobile sensor arrangement at least temporarily monitors a frontal protective field aligned with a direction of travel of the loading vehicle and is deactivated as soon as the structural boundary of the access zone is detected in the contour field when the loading vehicle is driven into the loading space.

The invention relates to a method for loading and/or unloading a loading space, in particular the loading space of a truck, using an autonomous loading vehicle and to a safeguarding system for safeguarding the loading and/or unloading of a loading space, in particular the loading space of a truck, using an autonomous loading vehicle according to the preamble of the independent claims.

The loading and unloading of a truck, in particular its semi-trailer, at a loading ramp, which is referred to as truck loading, has so far taken place manually using manned or person-driven forklift trucks. In this respect, it is the responsibility of the forklift operator or an operator to watch out for persons and to avoid accidents. Autonomous vehicles, so-called automated guided vehicles (AGVs), are indeed already being used in the logistics sector that would in principle be capable of taking over the truck loading or at least enabling a mixed operation between a manual operation and a fully automated operation. However, there is no solution for ensuring that no person is located in the semi-trailer, or on the path thereto, during the loading and unloading process. In other automated logistics applications, autonomous vehicles only work in zones closed off for persons. However, this cannot be implemented at a loading ramp.

Autonomous vehicles already monitor their journey with sensors, which are attached to the respective AGVs, in order to prevent accidents. In this respect, a protective field is, for example, produced or monitored in the direction of travel of the AGV. If an object is recognized in the protective field, a hazardous situation is assumed and the AGV is braked or stopped completely. Electrosensitive protective equipment that is based on a corresponding sensor is used for this purpose. The entry of an object or a person, in particular a body part of a person, into a protective field is recognized with the aid of one or more corresponding sensors without a direct mechanical contact taking place. Corresponding sensors are based on different physical principles. For example, optical sensors, acoustic sensors, such as ultrasonic sensors, inductive or capacitive sensors and radar sensors are used. Sensors that are used to avoid accidents have to work reliably and must therefore satisfy high safety demands, for example the standard IEN SO 13849 for safety of machinery and the machinery standard EN IEC 61496 for electrosensitive protective equipment (ESPE). To satisfy these safety standards, a series of measures have to be taken such as the safe electronic evaluation by redundant, diverse electronics, functional monitoring or monitoring of the contamination of optical components.

If said so-called automated guided vehicles (AGVs) are to be used for the automatic loading and unloading of truck trailers, the protective fields that are normally moved along with an AGV are a hindrance when navigating within the trailer since the protective field is virtually never free of objects due to the densely packed load present in the trailer or loading space and the vehicle is thus virtually no longer able to get out of a standstill. Furthermore, the currently available sensors are not capable of reliably distinguishing between persons and objects so that protective fields must consequently be switched off completely when navigating within the loading space. Nevertheless, it is necessary to ensure that access by persons is reliably recognized.

An object of the invention consequently comprises specifying a safe solution for the automated loading and unloading of the loading space of a truck, i.e. the loading and unloading of the loading space of the truck using at least one autonomous vehicle.

The object is satisfied by the method and the safeguarding system of the independent claims. Further developments and embodiments of the invention are the subject of the dependent claims in each case.

One embodiment of the invention relates to a method for loading and/or unloading a loading space, in particular the loading space of a truck, using an autonomous loading vehicle. The loading vehicle in this respect drives into the loading space at least once in order to pick up and/or place at least one load object. An access zone of the loading space is in this respect safeguarded by a stationary sensor device having at least a first sensor that is arranged at the access zone and that monitors a stationary protective field. The loading vehicle is safeguarded by a mobile sensor arrangement that is arranged at the loading vehicle and that at least temporarily monitors a contour field adapted to a structural boundary of the access zone. In this respect, the mobile sensor arrangement at least temporarily monitors a frontal protective field that is aligned with a direction of travel of the loading vehicle and that is deactivated as soon as the structural boundary of the access zone is detected in the contour field (i.e. by means of the contour field) on a driving of the loading vehicle into the loading space.

The method according to the invention enables a safe loading and unloading of the truck loading space using the autonomous loading vehicle by safeguarding the process via the stationary sensor device attached to the access zone, on the one hand, and by the sensor arrangement traveling along with the loading vehicle, on the other hand. With the aid of the stationary protective field, the stationary sensor device detects the access of, for example, a person to the loading space of the truck and its access zone that represent a hazardous zone for persons. The frontal protective field traveling along with the autonomous vehicle initially safeguards the driving of the loading vehicle into the loading space. At the same time, the contour field is monitored by the mobile sensor arrangement so that the exact point in time at which the autonomous loading vehicle actually reaches the loading space is detected. The frontal protective field is then deactivated or muted so that the loading vehicle can navigate within the loading space in an undisturbed manner, i.e. without an interruption. Potential access by persons to the loading space during the driving around of the autonomous loading vehicle in the loading space of the truck to place or pick up or collect the at least one load object is safeguarded by the stationary sensor device. The point in time at which the frontal protective field is deactivated is determined by the detection of the structural boundary of the access zone, for example, a side wall of a building that limits the access zone.

Therefore, the loading space is, for example, closed off by at least one wall and is thus only accessible, i.e. can be entered or driven into, through the access zone. The access zone represents the transition between, for example, a factory hall, in which load objects are stored, and the loading space or semi-trailer or trailer of a truck. A roller door can be attached to the access zone. The trailer is therefore driven up to the roller door and parked securely. The roller door is then opened by authorized operators. A platform is configured to the correct height under certain circumstances. After the authorized operators have made sure that there is no person in the loading space of the truck, the method according to the invention is started. As a rule, the autonomous vehicle, which is, for example, realized as an AGV or as an Autonomous Mobile Robot, AMR, drives into and out of the loading space again several times so that the method according to the invention can be carried out several times in succession.

The access zone that represents the only possibility of entering the loading space of the truck is safeguarded by the stationary sensor device comprising the at least one first sensor. The autonomous loading vehicle is safeguarded by the mobile sensor arrangement that likewise has at least one sensor. The at least one sensor of the mobile sensor arrangement is, for example, an optical sensor that is in particular based on the principle of the time-of-flight measurement.

The initially listed definitions also apply to the following text, unless explicitly stated otherwise.

To monitor a protective field, a sensor is configured so that the presence of an object is detected in a region or section from the field of view of the sensor that is defined as a protective field. Such a protective field can be activated or also set so that a detection of an object in the region of said protective field actually takes place. If a protective field is deactivated or muted, an object entering the protective field is ignored. A protective field can also be called a monitoring field. The contour field is a special protective field that is configured to detect an object, in particular its contour, in a defined region. In other words, the contour field of the AGV is indeed similar to a protective field, but it is specifically designed for the detection of objects in the region of the contour field, wherein a detection of an object then leads to a corresponding measure. According to the invention, the contour field is in particular solely configured for the positive detection of an object, here of the structural boundary of the loading space, i.e., for example, a hall wall. The contour field of the mobile sensor arrangement is determined, for example, during the configuration of the sensor of the mobile sensor arrangement by a person performing the putting into operation.

According to a further development, the stationary sensor device and the mobile sensor arrangement communicate with one another in order to safeguard at least the loading space against an entry by a person and/or a driving in by a loading vehicle that has not been registered. This in particular takes place by using a wireless communication device that is in particular realized as a wireless local area network.

An information exchange i.e. a communication, between the stationary sensor device and the mobile sensor arrangement takes place during the driving in and during the travel movements which the autonomous loading vehicle performs within the loading space of the truck. If, for example, the stationary sensor arrangement detects the entry of a person during the movements within the loading space by the AGV, it informs the AGV of this via the wireless communication device. Thus, a possibly imminent danger can be proactively addressed and the loading space is safeguarded in a safety-oriented manner at all times.

The wireless local network can, for example, be implemented as a wireless local area network, WLAN. Conventional protocols are used for the communication between the mobile sensor arrangement and the stationary sensor device, for example, the Transport Control Protocol, TCP, that is based on the Internet Protocol IP, i.e. TCP/IP. The protocols used are in this respect safeguarded in the usual way in terms of machine safety, for example, by using safe TCP/IP protocols such as EFIpro or ProfiNET/ProfiSAFE.

According to a further development, on an approach of the loading vehicle to the access zone and before the driving into the access zone, a registration of the loading vehicle at the stationary sensor device takes place. The registration of the loading vehicle comprises checking an identity of the loading vehicle based on a unique identifier that is in particular given by a network address of the loading vehicle.

The AGV therefore drives up to the access zone and registers with the stationary sensor device, for example, by sending a corresponding message via the wireless communication device. For example, an IP address or a Medium Access Control (MAC) address of the loading vehicle is used for the identification of the loading vehicle. If the identification is successful, the further travel of the loading vehicle is enabled or authorized. When the access zone is driven through by the now registered AGV, the stationary protective field of the stationary sensor device is made permeable for precisely this AGV, i.e. it is muted for the passage of the authorized loading vehicle. As already mentioned above, the driving into by a non-registered loading vehicle or an entry by a person is furthermore detected by the stationary sensor device.

In a further development, after the registration of the loading vehicle, the mobile sensor arrangement of the loading vehicle monitors at least one lateral protective field that is oriented along a side of the loading vehicle extending parallel to the direction of travel of the loading vehicle and that serves to detect a person or an object who or that is located next to the loading vehicle.

A protective field refers to a two-dimensional or three-dimensional region in each case. This region has defined dimensions and is monitored by a respective sensor of the stationary sensor device or the mobile sensor arrangement. In this respect, the protective fields of the mobile sensor arrangement or the autonomous loading vehicle are each protective fields that travel along with the loading vehicle. In contrast thereto, the stationary sensor device monitors the stationary, i.e. localized, protective field. Objects, for example obstacles, and/or persons are detected in the respective protective field by the sensor. A corresponding action or reaction can then be triggered. For example, further travel of the loading vehicle can be prohibited.

The mobile sensor arrangement monitors or produces at least one lateral protective field. Preferably, the mobile sensor arrangement of the AGV monitors two lateral protective fields, which are each oriented along a side of the vehicle extending parallel to the direction of travel of the loading vehicle, after the registration at the stationary sensor device. Thus, the appearance of a person or an object can be detected on either side of the AGV.

According to a further development, the driving of the loading vehicle into the loading space that follows the registration at the stationary sensor device is enabled if neither the stationary sensor device nor the mobile sensor arrangement detects an object, in particular an object that has not been registered, in their respective protective fields.

After the successful registration at the stationary sensor device, which is acknowledged, for example, by a positive feedback from the stationary sensor device, the AGV preferably sets two lateral protective fields as well as the frontal protective field and continues its movement in the direction of the access zone. The frontal protective field of the autonomous loading vehicle in this respect at least partly overlaps the stationary protective field of the stationary sensor device. The actual driving of the loading vehicle into the loading space of the truck is only enabled if both the stationary protective field and all the protective fields of the AGV are free of persons or objects.

In a further embodiment, after the driving into the loading space has been enabled, the mobile sensor arrangement of the loading vehicle monitors or sets at least one rear protective field that is oriented in the opposite direction to the direction of travel of the loading vehicle and that serves to detect a person who is located behind the loading vehicle.

The AGV therefore moves further forward in the direction of the loading space and now additionally activates the rear protective field to detect any persons walking behind the loading vehicle. As soon as the contour field positively detects the structural boundary of the loading space, i.e., for example, the building wall, the frontal protective field is first muted.

According to a further development, as soon as the loading vehicle has passed the access zone, all the protective fields and the contour field of the mobile sensor arrangement of the loading vehicle are +deactivated for a navigation of said loading vehicle in the loading space.

The point in time at which the loading vehicle has completely passed the access zone can be seen, for example, in that the stationary protective field of the stationary sensor device no longer detects an object. From this point in time onwards, the autonomous vehicle navigates within the loading space of the truck using the mobile sensor arrangement without any protective fields. The protective fields of the AGV are therefore deactivated or muted in the loading space. One or more load objects are placed in or picked up from the loading space. The unmanned loading vehicle can advantageously continue to move in an autonomous manner in the loading space of the truck and can transport load objects back and forth without its journey being repeatedly interrupted by precisely these objects. If a person attempts to enter the loading space via the access zone during this time, this is detected by the stationary sensor device in its protective field and communicated to the loading vehicle. The loading vehicle can be stopped in this way. Thus, the automated loading and unloading of the truck is safe at all times.

According to one embodiment, the loading vehicle assumes a safety state as soon as a communication between the stationary sensor device and the mobile sensor arrangement breaks down. The loading vehicle stops in the safety state. Alternatively, at least the frontal protective field of the mobile sensor arrangement is activated, in particular all the protective fields of the mobile sensor arrangement, such as the rear protective field and one or two lateral protective fields, are activated.

If the communication via the wireless network between the stationary sensor device and the mobile sensor arrangement no longer functions, i.e. breaks off, the further travel of the autonomous loading vehicle is prohibited. Alternatively, either only the frontal protective field of the AGV is activated or all the protective fields of the AGV are activated. In other words, the preceding muting or deactivation of the protective fields of the AGV is ended.

According to a further development, the autonomous loading vehicle drives out of the loading space after placing and/or picking up the load object, in particular using the same path as when driving in. In this respect, during the driving out, the frontal protective field of the mobile sensor arrangement, which is oriented in the direction of travel of the loading vehicle, is first activated as soon as a front part of the loading vehicle passes the access zone. Then, at least one lateral protective field of the mobile sensor arrangement or of the AGV, which is oriented along a side of the loading vehicle extending parallel to the direction of travel of the vehicle, is activated as soon as the loading vehicle has completely passed the access zone.

After the AGV has stowed or picked up its load in the trailer, it leaves the loading space or access zone on the same path as during the driving in. As soon as the stationary protective field of the stationary sensor device detects the entry of the AGV from the direction of the loading space, i.e. when the front part of the loading vehicle that drives out first drives over the access zone, the protective field of the AGV directed in the driving-out direction is activated. Regardless of whether the AGV has turned in the loading space or not, this protective field corresponds to the frontal protective field oriented in the direction of travel. As soon as the vehicle has driven over the access zone in its entire vehicle length, i.e. completely, by continuing the driving out, the other mobile protective fields of the AGV are also reactivated. A loading cycle comprising the approach, the driving in, the loading and the driving out is thus completed.

According to a further development, the stationary sensor arrangement has a second sensor arranged at the access zone. In this respect, the first sensor and the second sensor are attached at oppositely disposed sides of the access zone, preferably at the oppositely disposed sides of the structural boundary. The second sensor produces a further stationary protective field that at least partly overlaps the stationary protective field of the first sensor.

The first and the second sensor of the stationary sensor device each operate according to an electrosensitive sensor principle, preferably according to an optical sensor principle such as a light grid, a laser scanner, a lidar sensor, a camera or a 3D camera, in particular a time-of-flight camera, but also according to non-optical sensor principles such as a radar or a radio location system, in particular an ultra-wideband system. The first and the second sensor can in this respect be selected as required from the aforementioned and further electrosensitive sensors. For example, the first and the second sensor are each implemented as a safety laser scanner.

According to a further development, the access zone is divided into at least two separate regions, which form at least a first and a second drive-through corridor for passing through the access zone, on the basis of the stationary protective fields of the stationary sensor device. The loading vehicle uses the first or the second drive-through corridor for the driving in and the driving out. The loading vehicle enters a safety state as soon as the stationary sensor device detects an object in the drive-through corridor that is not used for the current driving in or driving out. The loading vehicle stops in the safety state. Alternatively, at least the frontal protective field of the mobile sensor arrangement is activated, in particular all the protective fields of the mobile sensor arrangement, such as the rear protective field and one or two lateral protective fields, are activated.

If, as in this embodiment, the access zone is safeguarded with two sensors of the stationary sensor device, at least two drive-through corridors, which are each also referred to as a lane, can thereby be formed. These lanes are present in a purely virtual form. By using a drive-through corridor, only a part of the total width of the access zone can in each case be used for the driving in or driving out of an AGV registered at this corridor or this lane. In this respect, the respective stationary protective field of the first and/or second sensor is partially deactivated for the passage of the AGV, which is properly registered as described above, in this region. At the same time, the stationary protective fields in the region of the other drive-through corridors remain activated. As already described above, an autonomous loading vehicle uses the same path for the driving in and driving out, i.e. the same drive-through corridor. If one of the stationary protective fields reports the detection of an object in the drive-through corridor that is not used for the current driving in, the loading vehicle is switched to a safety state. In this respect, either any autonomous movement is prevented or one or all of the protective fields of the mobile sensor arrangement are activated.

In a further development, after a stopping of the loading vehicle that is in a safety state, the loading vehicle, after switching on a manual control, is driven out of the loading space using this control.

If, therefore, during its movements for the loading and unloading in the loading space of the truck, the AGV is prevented from continuing its autonomous further travel in a safety-related manner, i.e. due to the detection of an object in the stationary protective field or in the stationary protective fields, it is possible to drive the AGV out of the loading space using the manual control. For this purpose, an enabling device can be provided at the AGV, for example, in the form of a switch or a human-machine interface (HMI), in particular a touchscreen.

A further embodiment of the invention relates to a safeguarding system for safeguarding a loading and/or unloading of a loading space, in particular the loading space of a truck, using an autonomous loading vehicle that drives into the loading space at least once in order to pick up and/or place at least one load object. The safeguarding system has a stationary sensor device and a mobile sensor arrangement arranged at the loading vehicle. The stationary sensor device is configured to safeguard an access zone of the loading space and has at least a first sensor arranged at the access zone. Said first sensor is configured to monitor a stationary protective field. The mobile sensor arrangement is configured to safeguard the loading vehicle and to at least temporarily monitor a contour field adapted to a structural boundary of the access zone. Furthermore, the mobile sensor arrangement is configured to at least temporarily monitor a frontal protective field aligned with a direction of travel of the loading vehicle and to deactivate said frontal protective field when the structural boundary of the access zone is detected in the contour field during a driving of the loading vehicle into the loading space.

In the safeguarding system, the contour field is inter alia used to recognize when the autonomous loading vehicle actually drives into the loading space, i.e. in this case when the contour field of the AGV recognizes the contour of the structural boundary of the access zone. From this point in time onwards, at least the frontal protective field aligned with the direction of travel of the loading vehicle is deactivated so that the autonomous loading vehicle can then move in the loading space to place or pick up load objects. In the meantime, a safeguarding against persons accessing the loading space is implemented by the stationary sensor device. Thus, an automated loading and unloading of the loading space of the truck by autonomous vehicles is made possible with the required level of safety.

In one realization possibility, the method described above is carried out by the described and claimed safeguarding system. In all other respects, the statements on the method according to the invention apply accordingly to the safeguarding system, in particular with respect to advantages and embodiments or further developments.

In a further development, the first sensor of the stationary sensor device comprises a contactless sensor, in particular a laser scanner. Alternatively or additionally, the mobile sensor arrangement comprises at least one sensor that has a contactless sensor, in particular a laser scanner.

In a further development, the stationary sensor device comprises a second sensor that is arranged at the access zone and that is configured to monitor a further stationary protective field, wherein the first and the second sensor are attached at mutually oppositely disposed sides, preferably the structural boundary, of the access zone. The stationary protective field of the first sensor at least partly overlaps the stationary protective field of the second sensor.

In this respect, each laser scanner is in particular implemented as a safety laser scanner.

The embodiments and further developments mentioned can be combined with one another, unless explicitly stated or described otherwise.

The invention will be explained by way of example in the following with reference to the Figures. Elements with the same function or the same effect bear the same reference signs. There are shown:

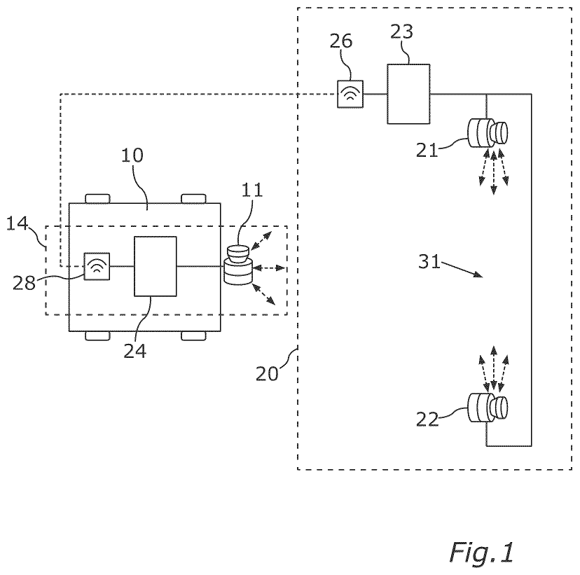

FIG. 1 an exemplary embodiment of a safeguarding system as proposed;

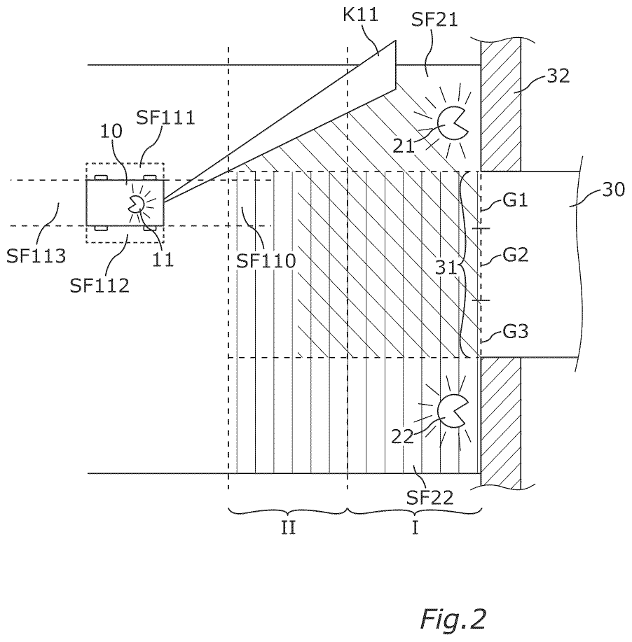

FIG. 2 an exemplary scenario in which the proposed method or the safeguarding system is used; and

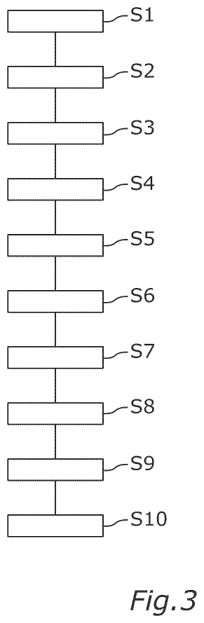

FIG. 3 an exemplary embodiment of the method as proposed.

FIG. 1 shows an exemplary embodiment of a safeguarding system as proposed. The safeguarding system comprises a stationary sensor device 20 and a mobile sensor arrangement 14 that is arranged at an autonomous loading vehicle 10. The safeguarding system is configured to safeguard the loading and/or unloading of a loading space, in particular the loading space of a truck, using the autonomous loading vehicle 10. In this respect, the autonomous loading vehicle 10 drives into the loading space at least once in order to place and/or pick up at least one load object. The stationary sensor device 20 is configured to safeguard an access zone 31 of the loading space of the truck. It comprises at least a first sensor 21. In this embodiment example, the stationary sensor device 20 additionally comprises a second sensor 22. The first and the second sensor 21, 22 are arranged at oppositely disposed sides of the access zone 31 in each case.

Optionally, the stationary sensor device 20 can comprise a further sensor, not shown in the Figure, e.g. in the form of a light grid. Said further sensor is linked to the other sensors 21, 22 by means of a logical OR function in the sensor device 20, in particular its control 24. This is particularly advantageous if a large number of persons are potentially moving in the access zone or in its vicinity. Shutdowns caused by persons walking past are prevented and the system availability is increased even further. An unintended detection in the region of the sensor arrangement 20 and the light grid leads to a setting of the AGV to the safe state.

The mobile sensor arrangement 14 comprises at least a third sensor 11 that is arranged at the autonomous loading vehicle 10 and thus travels along with it. In the Figures, only one sensor 11 is provided by way of example for the mobile sensor arrangement 14, for example in the direction of travel, but one or more further sensors can be added for a rear and/or side monitoring. As described, the sensors 21 and 22 operate according to an electrosensitive sensor principle, preferably according to an optical sensor principle. Non-optical sensor principles as in a radar or a radio location system, in particular an ultra-wideband system, can also be used. The sensors 21, 22 and 11 can be selected as desired from the mentioned sensors and further electrosensitive sensors, wherein some sensors are not equally suitable for both systems 20, 14, for example a light grid only for the stationary sensor device 20. The invention will be described in the following using the example of laser scanners. The object recognition is in this respect based on a protective field concept; this is also an example since it is only important to detect objects in the access zone 31 or in the respective travel path of the loading vehicle 10 in a safe manner.

A control and evaluation unit 22, 24 is provided in the stationary sensor device 20 and the mobile sensor device 14 in each case. The control and evaluation functionality with the method described in the following can practically be distributed as desired over the two control and evaluation units 22 24 and also over at least one external control and evaluation unit of a higher-ranking system. However, at least the respective object detection or protective field evaluation preferably takes place close to or in the associated sensor 21, 22, 11.

Any desired processing units can be considered as the hardware of the control and evaluation unit 22, 24; for instance, digital processing modules such as a microprocessor or a central processing unit, CPU, a field programmable gate array, FPGA, a digital signal processor, DSP, an application specific integrated circuit, ASIC, an AI processor, a neural processing unit, NPU, a graphics processing unit, GPU, or the like. An external processing unit can be a computer of any desired kind, including notebooks, smartphones, tablets, a (safety) controller, equally a local network device, an edge device, or a device in a cloud. Safety-related parts of the control and evaluation are preferably executed on safe hardware or reach a required safety level by other measures such as redundancy or tests.

Furthermore, a communication interface 26, 28 is provided in the stationary sensor device 20 and in the mobile sensor device 14 in each case. Furthermore, the stationary sensor device 20 and the mobile sensor device 14 are preferably wirelessly connected to one another to exchange data, information and control signals. The communication connections can be implemented via any desired protocol such as Bluetooth, wireless LAN, WiFi, 3G/4G/5G, and in principle any other protocol.

FIG. 2 shows an exemplary scenario in which the proposed safeguarding system, as shown by way of example in FIG. 1, and the proposed method are used. In this exemplary embodiment, the stationary sensor device also comprises the first and the second sensor 21, 22. The first sensor 21 produces a first stationary protective field SF21. The second sensor 22 produces a second stationary protective field SF22. The protective fields SF21 and SF22 partly overlap. The access zone 31 is bounded at both sides by a structural boundary 32, for example a wall. In the representation shown, the truck to be loaded or unloaded drives backwards from the right with its trailer or semi-trailer towards the access zone 31. Authorized operators take steps to prepare for the automated loading or unloading of the loading space 30, for example, by opening a roller door at the access zone 31, checking that the loading space 30 is clear of persons and enabling the automated loading according to the proposed method.

As shown, the sensors 21 and 22 are laterally arranged at the access zone 31, in particular at its structural boundary 32. In the example of FIG. 2, three drive-through corridors G1, G2 and G3 are virtually formed in the access zone 31 on the basis of the protective fields SF21 and SF22. Said drive-through corridors are each so wide that an autonomous loading vehicle 10 can drive into the loading space 30 via this drive-through corridor due to a partial deactivation of the protective field(s) SF21, SF22 in this region after registering at the stationary sensor arrangement 20.

The mobile sensor arrangement comprises the third sensor 11 that is configured to at least temporarily monitor a frontal protective field SF110, a first lateral protective field SF111, a second lateral protective field SF112 and a rear protective field SF113. Furthermore, the third sensor 11 monitors the contour field K11.

Each of the stationary protective fields SF21 and SF22 can furthermore be divided into an inner region I and an outer region II in each case, as shown. The inner region I of a respective stationary protective field SF21, SF22 in this respect directly adjoins the access zone 31, while the respective outer region II of the stationary protective fields SF21, SF22 adjoins the side of the inner region I facing away from the access zone 31.

The method according to the invention is explained in more detail in the following using the scenario of FIG. 2 in conjunction with the exemplary embodiment of FIG. 3.

In step S1, the autonomous loading vehicle 10 approaches the safeguarding system according to the invention and registers with the stationary sensor device. Optionally, when registering, the loading vehicle 10 can additionally specify via which path, in this case via which of the drive-through corridors G1, G2 or G3, the access to the loading space 30 is to take place.

In step S2, after positive feedback from the stationary sensor device, the loading vehicle 10 activates the lateral monitoring fields SF111 and SF112 as well as the frontal protective field SF110 that overlaps with the outer region II of the stationary protective fields SF21 and SF22 in the region of an extension of the corridor G1.

In step S3, it is checked whether all the protective fields SF21, SF22 of the stationary sensor device and the protective fields SF110, SF111 and SF112 of the loading vehicle 10 are without an object detection. If this is the case, in step S4, the loading vehicle 10 receives clearance from the stationary sensor device to continue its journey.

In step S5, the rear protective field SF113 of the AGV 10 is activated on the further approach to the access zone 31, in particular on the reaching of the outer II and the inner I region of the stationary protective fields SF21, SF22. At this point in time, the contour field K11 is activated. The AGV moves onward.

In step S6, the contour field K11 detects the building wall 32, which leads to the deactivation of the frontal protective field SF110 of the loading vehicle 10.

In step S7, the loading vehicle 10 has completely driven into the loading space 30 so that none of the protective fields SF21 and SF22 detect the AGV 10 either in its inner or its outer region I, II. Now, all the protective fields of the AGV 10, i.e. also the lateral protective fields SF111 and SF112 and the rear protective field SF113, are muted. The AGV 10 can now carry out the required autonomous travel movements for placing or picking up the load object.

In step S8, the AGV 10 has completed the loading or unloading process and leaves the loading space on the same path as during the driving in. As soon as the inner region I of the stationary protective field SF21 detects the loading vehicle 10, the protective field SF113, which is now located in the direction of travel of the loading vehicle 10, is activated.

In step S9, as soon as the outer region II of the protective field SF21 detects the loading vehicle 10, the lateral protective fields SF111 and SF112 are also activated. This means that the loading vehicle 10 is driven in its full length out of the access zone 31 or the stationary protective fields SF21, SF22.

In step S10, the AGV 10 has left the region and all the protective fields required for free driving are activated in accordance with the vehicle configuration.

### REFERENCE NUMERAL LIST

10 loading vehicle
11, 21, 22 sensor
14 mobile sensor arrangement
20 stationary sensor device
26, 28 communication device
23, 24 control
30 loading space
31 access zone
32 structural boundary
SF21, SF22 stationary protective field
SF110, SF111, SF112, SF113 mobile protective field
K11 contour field
G1, G2, G3 drive-through corridor
I, II region
S1, S2, . . . , S10 step

1. A method for loading and/or unloading a loading space using an autonomous loading vehicle that drives into the loading space at least once in order to pick up and/or place at least one load object, wherein an access zone of the loading space is safeguarded by a stationary sensor device having at least a first sensor, which is arranged at the access zone and which monitors a stationary protective field, wherein the loading vehicle is safeguarded by a mobile sensor arrangement that is arranged at the loading vehicle and that at least temporarily monitors a contour field adapted to a structural boundary of the access zone, wherein the mobile sensor arrangement at least temporarily monitors a frontal protective field that is aligned with a direction of travel of the loading vehicle and that is deactivated as soon as the structural boundary of the access zone is detected in the contour field on a driving of the loading vehicle into the loading space.

2. The method according to claim 1,
wherein the stationary sensor device and the mobile sensor arrangement communicate with one another in order to safeguard at least the loading space against an entry by a person and/or a driving in by a loading vehicle that has not been registered.

3. The method according to claim 1,
wherein, on an approach of the loading vehicle to the access zone and before the driving into the access zone, a registration of the loading vehicle at the stationary sensor device takes place, wherein the registration of the loading vehicle comprises checking an identity of the loading vehicle based on a unique identifier.

4. The method according to claim 3,
wherein, after the registration of the loading vehicle, the mobile sensor arrangement of the loading vehicle monitors at least one lateral protective field that is oriented along a side of the loading vehicle extending parallel to the direction of travel of the loading vehicle and that serves to detect a person or an object who or that is located next to the loading vehicle.

5. The method according to claim 4,
wherein the driving of the loading vehicle into the loading space that follows the registration is enabled if neither the stationary sensor device nor the mobile sensor arrangement detects an object in their respective protective fields.

6. The method according to claim 5,
wherein, after the driving in has been enabled, the mobile sensor arrangement of the loading vehicle produces at least one rear protective field that is oriented in the opposite direction to the direction of travel of the loading vehicle and that serves to detect a person who is located behind the loading vehicle.

7. A method according to claim 6,
wherein, as soon as the loading vehicle has passed the access zone, all the protective fields and the contour field of the mobile sensor arrangement of the loading vehicle are deactivated for a navigation in the loading space.

8. The method according to claim 1,
wherein the loading vehicle assumes a safety state as soon as a communication between the stationary sensor device and the mobile sensor arrangement breaks down,
wherein, in the safety state, the loading vehicle stops or at least the frontal protective field produced by the mobile sensor arrangement are activated.

9. The method according to claim 1,
wherein the loading vehicle drives out of the loading space after placing and/or picking up the load object, and
wherein, during the driving out, the frontal protective field of the mobile sensor arrangement, which is oriented in the direction of travel of the loading vehicle, is first activated as soon as a front part of the loading vehicle passes the access zone and then at least one lateral protective field of the mobile sensor arrangement, which is oriented along a side of the loading vehicle extending parallel to the direction of travel of the loading vehicle, is activated as soon as the loading vehicle has completely passed the access zone.

10. The method according to claim 1,
wherein the stationary sensor device has a second sensor arranged at the access zone, wherein the first sensor and the second sensor are attached at oppositely disposed sides of the access zone, wherein the second sensor monitors a further stationary protective field, wherein the stationary protective field of the first sensor at least partly overlaps the stationary protective field of the second sensor.

11. The method according to claim 10,
wherein the access zone is divided into at least two separate regions, which form at least a first and a second drive-through corridor for passing through the access zone, on the basis of the stationary protective fields of the stationary sensor device, wherein the loading vehicle uses the first or the second drive-through corridor for the driving in and the driving out, and wherein the loading vehicle enters a safety state as soon as the stationary sensor device detects an object in the drive-through corridor that is not used for the current driving in,
wherein, in the safety state, the loading vehicle stops or at least the frontal protective field are monitored by the mobile sensor arrangement.

12. The method according to claim 11,
wherein, after a stopping of the loading vehicle that is in a safety state, the loading vehicle, after switching on a manual control, is driven out of the loading space using this control.

13. A safeguarding system for safeguarding a loading and/or unloading of a loading space using an autonomous loading vehicle that drives into the loading space at least once in order to pick up and/or place at least one load object,
wherein the safeguarding system has a stationary sensor device and a mobile sensor arrangement arranged at the loading vehicle,
wherein the stationary sensor device is configured to safeguard an access zone of the loading space and has at least a first sensor that is arranged at the access zone and that is configured to monitor a stationary protective field,
wherein the mobile sensor arrangement is configured to safeguard the loading vehicle and to at least temporarily monitor a contour field that is adapted to a structural boundary of the access zone,
wherein the mobile sensor arrangement is further configured to at least temporarily monitor a frontal protective field aligned with a direction of travel of the loading vehicle and to deactivate said frontal protective field when the structural boundary of the access zone is detected in the contour field during a driving of the loading vehicle into the loading space.

14. The safeguarding system according to claim 13,
wherein the first sensor of the stationary sensor device comprises a contactless sensor, and/or
wherein the mobile sensor arrangement comprises at least one sensor that has a contactless sensor.

15. The safeguarding system according to claim 14,
wherein the stationary sensor device comprises a second sensor that is arranged at the access zone and that is configured to monitor a further stationary protective field, wherein the first and the second sensor are attached at mutually oppositely disposed sides of the access zone, wherein the stationary protective field of the first sensor at least partly overlaps the stationary protective field of the second sensor.

16. The method according to claim 1, wherein the loading space is the loading space of a truck.

17. The method according to claim 2,
wherein the stationary sensor device and the mobile sensor arrangement communicate with one another using one of a wireless communication device and a wireless local area network.

18. The method according to claim 3,
wherein the unique identifier is given by a network address of the loading vehicle.

19. The method according to claim 5,
wherein the driving of the loading vehicle into the loading space that follows the registration is enabled if neither the stationary sensor device nor the mobile sensor arrangement detects an object that has not been registered.

20. The method according to claim 9,
wherein the loading vehicle drives out of the loading space after placing and/or picking up the load object using the same path as when driving in.

21. The method according to claim 10,
wherein the first sensor and the second sensor are attached at oppositely disposed sides at the structural boundary of the access zone.

22. The safeguarding system according to claim 14,
wherein the contactless sensor is a laser scanner.

23. The safeguarding system according to claim 15,
wherein the first and the second sensor are attached at the structural boundary of the access zone.
